(19) United States
(12) Patent Application Publication
(10) Pub. No.: US 2026/0079726 A1
(43) Pub. Date: Mar. 19, 2026

(54) SYSTEMS AND METHODS FOR GENERATING DATA VISUALIZATIONS OF PERFORMANCE INDICATORS

(71) Applicant: ServiceNow, Inc., Santa Clara, CA (US)

(72) Inventors: Radha Raman, Hyderabad (IN); Srikar Gullapalli, Hyderabad (IN); Aman Kumar Jain, Sagar (IN); Vinay Siddam, Hyderabad (IN); Akshay Narayan Hargude, Pune (IN); Abhinav Shekhar, Hyderabad (IN); Surbhi Agarwal, Hyderabad (IN)

(21) Appl. No.: 18/889,106

(22) Filed: Sep. 18, 2024

(51) Int. Cl. G06F 9/451; G06Q 10/0639

(52) U.S. Cl. CPC G06F 9/451; G06Q 10/06393

(57) ABSTRACT

The present discussion relates to using a natural language request to generate a dashboard, the natural language request specifying a use case of the dashboard. Such techniques may also include receiving a system prompt comprising one or more key performance indicators (KPIs), identifying, using a large language model (LLM), an applicable KPI of the one or more KPIs based on the use case of the dashboard, identifying a data visualization for the applicable KPI, generating a dashboard including the data visualization for the applicable KPI.

### BACKGROUND

The present disclosure relates generally to analysis of key performance indicators (KPIs). Specifically, the present disclosure relates to generating data visualizations of KPIs.

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Key performance indicators (KPIs) may include measurable values that assess how effectively a business or organization is achieving its objectives, and may be used to identify trends and make data-driven decisions. KPIs may include, for example, revenue metrics, churn rates, website traffic, and the like. Further, KPIs may be aggregated and analyzed via one or more data visualizations, such as score displays, pie charts, bar charts, and so on. However, identifying applicable KPIs and developing useful data visualizations may be computationally expensive, as organizations may track numerous KPIs, each having various data source definitions, units, directions, precisions, aggregates, and other parameters. With so many KPIs and associated parameters, it may be difficult to identify and efficiently produce visualizations of applicable KPIs, which may lead to the omission of important data when making organizational decisions.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

Various embodiments disclosed herein are directed to a dashboard builder that displays data visualizations of KPIs based on natural language inputs provided to large language models (LLMs). Specifically, a natural language input identifying one or more use cases of a dashboard (e.g., “create a dashboard which helps me analyze, open, and close overdue and high priority incidents”), also referred to herein as a natural language input or natural language prompt, may be provided as an input. Additionally, the dashboard builder may receive a system prompt including KPIs associated with an organization, parameters of the KPIs, and descriptions of how to use each KPI. The dashboard builder may provide the natural language input and the system prompt to one or more LLMs trained on other use cases and/or other KPIs.

The one or more LLMs may, based on the natural language input and the system prompt, identify one or more applicable KPIs for which to generate one or more data visualizations. The dashboard builder may then determine whether one or more previously-generated data visualizations are associated with each applicable KPI. If one or more previously-generated data visualizations are associated with the applicable KPI, the dashboard builder may map the one or more previously-generated data visualizations to the applicable KPI. If no data visualization is associated with the applicable KPI, the dashboard builder may generate one or more data visualizations based on the KPI and information associated with the KPI included in the system prompt. After mapping or generating one or more data visualizations for each applicable KPI, the dashboard builder may generate and/or cause the display of a dashboard including the one or more data visualizations.

Additional natural language inputs (e.g., “show me incident-related indicators of potential breaches”) may be provided, and the dashboard builder may update the dashboard based on the additional natural language inputs. For example, the dashboard builder may provide the additional natural language inputs and the system prompt to the one or more LLMs, and the one or more LLMs may identify one or more additional applicable KPIs of the one or more KPIs. The dashboard builder may map one or more additional previously-generated data visualizations to the additional applicable KPIs or, alternatively, may generate the one or more additional data visualizations. The dashboard builder may then update the dashboard to include the one or more additional data visualizations.

In one embodiment, a method includes receiving a natural language request to generate a dashboard, the natural language request specifying a use case of the dashboard. The method also includes receiving a system prompt comprising one or more key performance indicators (KPIs), identifying, using a large language model (LLM), an applicable KPI of the one or more KPIs based on the use case of the dashboard, identifying a data visualization for the applicable KPI, generating a dashboard including the data visualization for the applicable KPI.

In another embodiment a system includes processing circuitry and a memory, accessible by the processing circuitry, and storing instructions that, when executed by the processing circuitry, cause the processing circuitry to perform operations including receiving a natural language request to generate a dashboard, the natural language request specifying a use case of the dashboard, receiving a system prompt comprising one or more key performance indicators (KPIs), identifying, using a large language model (LLM), an applicable KPI of the one or more KPIs based on the use case of the dashboard, identifying a data visualization for the applicable KPI, and generating a dashboard including the data visualization for the applicable KPI.

In yet another embodiment, a non-transitory, computer readable medium comprising instructions is provided that, when executed by processing circuitry, cause the processing circuitry to perform operations including receiving a natural language request to generate a dashboard, wherein the natural language request specifies a use case of the dashboard, receiving a system prompt comprising one or more key performance indicators (KPIs), identifying, using a large language model (LLM), an applicable KPI of the one or more KPIs based on the use case of the dashboard, identifying a data visualization for the applicable KPI, and generating a dashboard including the data visualization for the applicable KPI.

Various refinements of the features noted above may exist in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended only to familiarize the reader with certain aspects and contexts of embodiments of the present disclosure without limitation to the claimed subject matter.

### BRIEF DESCRIPTION OF THE DRAWINGS

Various aspects of this disclosure may be better understood upon reading the following detailed description and upon reference to the drawings in which:

FIG. 1 is a block diagram of an embodiment of a multi-instance cloud architecture in which embodiments of the present disclosure may operate;

FIG. 2 is a schematic diagram of an embodiment of a multi-instance cloud architecture in which embodiments of the present disclosure may operate;

FIG. 3 is a block diagram of a computing device utilized in a computing system that may be present in FIG. 1 or 2, in accordance with aspects of the present disclosure;

FIG. 4 is a block diagram illustrating an embodiment in which a virtual server supports and enables a client instance, on which a dashboard builder tool may operate, in accordance with aspects of the present disclosure;

FIG. 5 is a screenshot of a workspace that displays a dashboard, generated using the dashboard builder tool of FIG. 4, and including data visualizations of applicable KPIs, in accordance with aspects of the present disclosure; and

FIG. 6 is a flow chart of a process for generating the dashboard of FIG. 5, including data visualizations of the applicable KPIs, in accordance with aspects of the present disclosure.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers'specific goals, such as compliance with system-related and enterprise-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

As used herein, the term “computing system” refers to an electronic computing device such as, but not limited to, a single computer, virtual machine, virtual container, host, server, laptop, and/or mobile device, or to a plurality of electronic computing devices working together to perform the function described as being performed on or by the computing system. As used herein, the term “medium” refers to one or more non-transitory, computer-readable physical media that together store the contents described as being stored thereon. Embodiments may include non-volatile secondary storage, read-only memory (ROM), and/or random-access memory (RAM). As used herein, the term “application” refers to one or more computing modules, programs, processes, workloads, threads and/or a set of computing instructions executed by a computing system. Example embodiments of an application include software modules, software objects, software instances and/or other types of executable code.

As mentioned, key performance indicators (KPIs) may include measurable values that assess how effectively a business or organization is achieving its objectives, and may be used to identify trends and make data-driven decisions. KPIs may include, for example, revenue metrics, churn rates, website traffic, and the like. Further, KPIs may be aggregated and analyzed via one or more data visualizations, such as score displays, pie charts, bar charts, and so on. However, identifying applicable KPIs and developing useful data visualizations may be computationally expensive, as organizations may track numerous KPIs, each having various data source definitions, units, directions, precisions, aggregates, and other parameters. With so many KPIs and associated parameters, it may be difficult to identify and efficiently produce visualizations of applicable KPIs, which may lead to the omission of important data when making organizational decisions.

Various embodiments disclosed herein are directed to a dashboard builder tool or routines that generates and/or causes the display of data visualizations of KPIs based on natural language inputs provided to large language models (LLMs). Specifically, a natural language input identifying one or more use cases of a dashboard (e.g., “create a dashboard which helps me analyze, open, and close overdue and high priority incidents”) may be provided as an input. Additionally, the dashboard builder may receive a system prompt including KPIs associated with an organization, parameters of the KPIs, and descriptions of how to use each KPI. The dashboard builder may provide the natural language input and the system prompt to one or more LLMs trained on other use cases and/or other KPIs.

The one or more LLMs may, based on the natural language input and the system prompt, identify one or more applicable KPIs for which to generate one or more data visualizations. The dashboard builder may then determine whether one or more previously-generated data visualizations are associated with each applicable KPI. If one or more previously-generated data visualizations are associated with the applicable KPI, the dashboard builder may map the one or more previously-generated data visualizations to the applicable KPI. If no data visualization is associated with the applicable KPI, the dashboard builder may generate one or more data visualizations based on the KPI and information associated with the KPI included in the system prompt. After mapping or generating one or more data visualizations for each applicable KPI, the dashboard builder may generate and/or otherwise cause the display of a dashboard including the one or more data visualizations.

Additional natural language inputs (e.g., “show me incident-related indicators of potential breaches”) may be provided, and the dashboard builder may update the dashboard based on the additional natural language inputs. For example, the dashboard builder may provide the additional natural language inputs and the system prompt to the one or more LLMs, and the one or more LLMs may identify one or more additional applicable KPIs of the one or more KPIs. The dashboard builder may map one or more additional previously-generated data visualizations to the additional applicable KPIs or, alternatively, may generate the one or more additional data visualizations. The dashboard builder may then update the dashboard to include the one or more additional data visualizations.

Traditionally, numerous KPIs of an organization may be manually searched for applicability to a certain use case, and data visualizations may be manually developed for those applicable KPIs, which may be time consuming and inefficient. Use of the disclosed techniques may result in faster and more computationally efficient generation of data visualization of KPIs, as well as more interpretable and complete data visualizations of KPIs. Further, because the disclosed techniques identify applicable KPIs for which to make data visualizations based on a use case specified by a natural language input, the disclosed techniques may produce data visualizations that provide a holistic and easily-interpretable overview of KPIs associated with a use case.

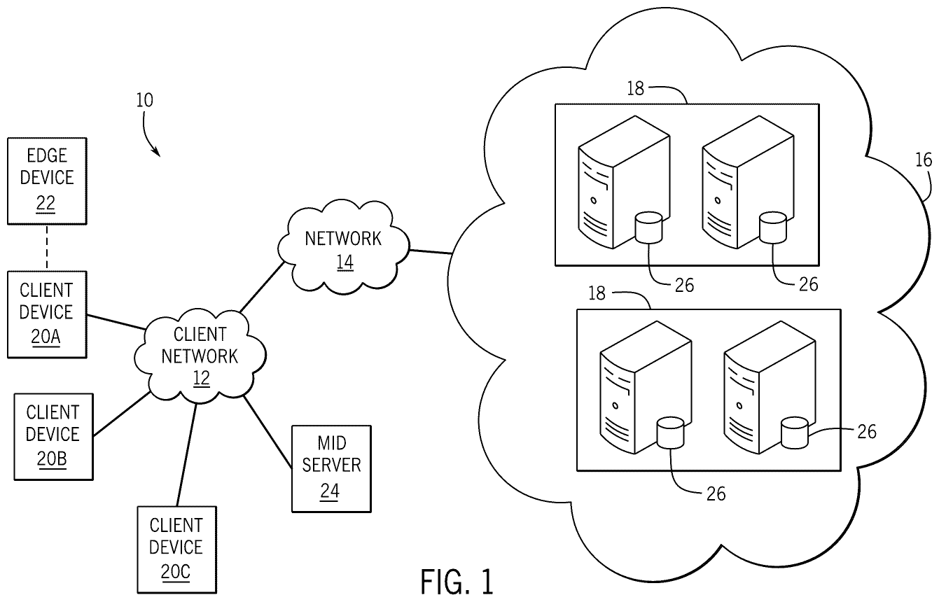

With the preceding in mind, the following figures relate to various types of generalized system architectures or configurations that may be employed to provide services to an organization in a multi-instance framework and on which the present approaches may be employed. Correspondingly, these system and platform examples may also relate to systems and platforms on which the techniques discussed herein may be implemented or otherwise utilized. Turning now to FIG. 1, a schematic diagram of an embodiment of a cloud computing system 10 where embodiments of the present disclosure may operate, is illustrated. The cloud computing system 10 may include a client network 12, a network 14 (e.g., the Internet), and a cloud-based platform 16. In some implementations, the cloud-based platform 16 may be a configuration management database (CMDB) platform. In one embodiment, the client network 12 may be a local private network, such as local area network (LAN) having a variety of network devices that include, but are not limited to, switches, servers, and routers. In another embodiment, the client network 12 represents an enterprise network that could include one or more LANs, virtual networks, data centers 18, and/or other remote networks. As shown in FIG. 1, the client network 12 is able to connect to one or more client devices 20A, 20B, and 20C so that the client devices are able to communicate with each other and/or with the network hosting the platform 16. The client devices 20 may be computing systems and/or other types of computing devices generally referred to as Internet of Things (IoT) devices that access cloud computing services, for example, via a web browser application or via an edge device 22 that may act as a gateway between the client devices 20 and the platform 16. FIG. 1 also illustrates that the client network 12 includes an administration or managerial device, agent, or server, such as a management, instrumentation, and discovery (MID) server 24 that facilitates communication of data between the network hosting the platform 16, other external applications, data sources, and services, and the client network 12. Although not specifically illustrated in FIG. 1, the client network 12 may also include a connecting network device (e.g., a gateway or router) or a combination of devices that implement a customer firewall or intrusion protection system.

For the illustrated embodiment, FIG. 1 illustrates that client network 12 is coupled to a network 14. The network 14 may include one or more computing networks, such as other LANs, wide area networks (WAN), the Internet, and/or other remote networks, to transfer data between the client devices 20 and the network hosting the platform 16. Each of the computing networks within network 14 may contain wired and/or wireless programmable devices that operate in the electrical and/or optical domain. For example, network 14 may include wireless networks, such as cellular networks (e.g., Global System for Mobile Communications (GSM) based cellular network), IEEE 802.11 networks, and/or other suitable radio-based networks. The network 14 may also employ any number of network communication protocols, such as Transmission Control Protocol (TCP) and Internet Protocol (IP). Although not explicitly shown in FIG. 1, network 14 may include a variety of network devices, such as servers, routers, network switches, and/or other network hardware devices configured to transport data over the network 14.

In FIG. 1, the network hosting the platform 16 may be a remote network (e.g., a cloud network) that is able to communicate with the client devices 20 via the client network 12 and network 14. The network hosting the platform 16 provides additional computing resources to the client devices 20 and/or the client network 12. For example, by utilizing the network hosting the platform 16, users of the client devices 20 are able to build and execute applications for various enterprise, IT, and/or other organization-related functions. In one embodiment, the network hosting the platform 16 is implemented on the one or more data centers 18, where each data center could correspond to a different geographic location. Each of the data centers 18 includes a plurality of virtual servers 26 (also referred to herein as application nodes, application servers, virtual server instances, application instances, or application server instances), where each virtual server 26 can be implemented on a physical computing system, such as a single electronic computing device (e.g., a single physical hardware server) or across multiple-computing devices (e.g., multiple physical hardware servers). Examples of virtual servers 26 include, but are not limited to a web server (e.g., a unitary Apache installation), an application server (e.g., unitary JAVA Virtual Machine), and/or a database server (e.g., a unitary relational database management system (RDBMS) catalog).

To utilize computing resources within the platform 16, network operators may choose to configure the data centers 18 using a variety of computing infrastructures. In one embodiment, one or more of the data centers 18 are configured using a multi-tenant cloud architecture, such that one of the server instances 26 handles requests from and serves multiple customers. Data centers 18 with multi-tenant cloud architecture commingle and store data from multiple customers, where multiple customer instances are assigned to one of the virtual servers 26. In a multi-tenant cloud architecture, the particular virtual server 26 distinguishes between and segregates data and other information of the various customers. For example, a multi-tenant cloud architecture could assign a particular identifier for each customer in order to identify and segregate the data from each customer. Generally, implementing a multi-tenant cloud architecture may suffer from various drawbacks, such as a failure of a particular one of the server instances 26 causing outages for all customers allocated to the particular server instance.

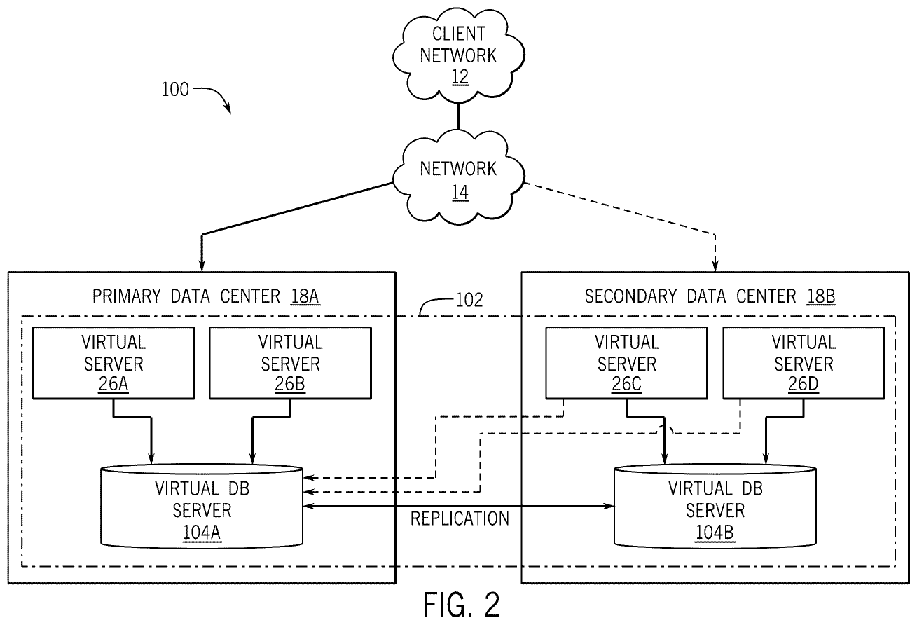

In another embodiment, one or more of the data centers 18 are configured using a multi-instance cloud architecture to provide every customer its own unique customer instance or instances. For example, a multi-instance cloud architecture could provide each customer instance with its own dedicated application server(s) and dedicated database server(s). In other examples, the multi-instance cloud architecture could deploy a single physical or virtual server 26 and/or other combinations of physical and/or virtual servers 26, such as one or more dedicated web servers, one or more dedicated application servers, and one or more database servers, for each customer instance. In a multi-instance cloud architecture, multiple customer instances could be installed on one or more respective hardware servers, where each customer instance is allocated certain portions of the physical server resources, such as computing memory, storage, and processing power. By doing so, each customer instance has its own unique software stack that provides the benefit of data isolation, relatively less downtime for customers to access the platform 16, and customer-driven upgrade schedules. An example of implementing a customer instance within a multi-instance cloud architecture will be discussed in more detail below with reference to FIG. 2.

FIG. 2 is a schematic diagram of an embodiment of a multi-instance cloud architecture 100 where embodiments of the present disclosure may operate. FIG. 2 illustrates that the multi-instance cloud architecture 100 includes the client network 12 and the network 14 that connect to two (e.g., paired) data centers 18A and 18B that may be geographically separated from one another and provide data replication and/or failover capabilities. Using FIG. 2 as an example, network environment and service provider cloud infrastructure client instance 102 (also referred to herein as a client instance 102) is associated with (e.g., supported and enabled by) dedicated virtual servers (e.g., virtual servers 26A, 26B, 26C, and 26D) and dedicated database servers (e.g., virtual database servers 104A and 104B). Stated another way, the virtual servers 26A-26D and virtual database servers 104A and 104B are not shared with other client instances and are specific to the respective client instance 102. In the depicted example, to facilitate availability of the client instance 102, the virtual servers 26A-26D and virtual database servers 104A and 104B are allocated to two different data centers 18A and 18B so that one of the data centers 18 acts as a backup data center. Other embodiments of the multi-instance cloud architecture 100 could include other types of dedicated virtual servers, such as a web server. For example, the client instance 102 could be associated with (e.g., supported and enabled by) the dedicated virtual servers 26A-26D, dedicated virtual database servers 104A and 104B, and additional dedicated virtual web servers (not shown in FIG. 2).

Although FIGS. 1 and 2 illustrate specific embodiments of a cloud computing system 10 and a multi-instance cloud architecture 100, respectively, the disclosure is not limited to the specific embodiments illustrated in FIGS. 1 and 2. For instance, although FIG. 1 illustrates that the platform 16 is implemented using data centers, other embodiments of the platform 16 are not limited to data centers and can utilize other types of remote network infrastructures. Moreover, other embodiments of the present disclosure may combine one or more different virtual servers into a single virtual server or, conversely, perform operations attributed to a single virtual server using multiple virtual servers. For instance, using FIG. 2 as an example, the virtual servers 26A, 26B, 26C, 26D and virtual database servers 104A, 104B may be combined into a single virtual server. Moreover, the present approaches may be implemented in other architectures or configurations, including, but not limited to, multi-tenant architectures, generalized client/server implementations, and/or even on a single physical processor-based device configured to perform some or all of the operations discussed herein. Similarly, though virtual servers or machines may be referenced to facilitate discussion of an implementation, physical servers may instead be employed as appropriate. The use and discussion of FIGS. 1 and 2 are only examples to facilitate ease of description and explanation and are not intended to limit the disclosure to the specific examples illustrated therein.

As may be appreciated, the respective architectures and frameworks discussed with respect to FIGS. 1 and 2 incorporate computing systems of various types (e.g., servers, workstations, client devices, laptops, tablet computers, cellular telephones, and so forth) throughout. For the sake of completeness, a brief, high level overview of components typically found in such systems is provided. As may be appreciated, the present overview is intended to merely provide a high-level, generalized view of components typical in such computing systems and should not be viewed as limiting in terms of components discussed or omitted from discussion.

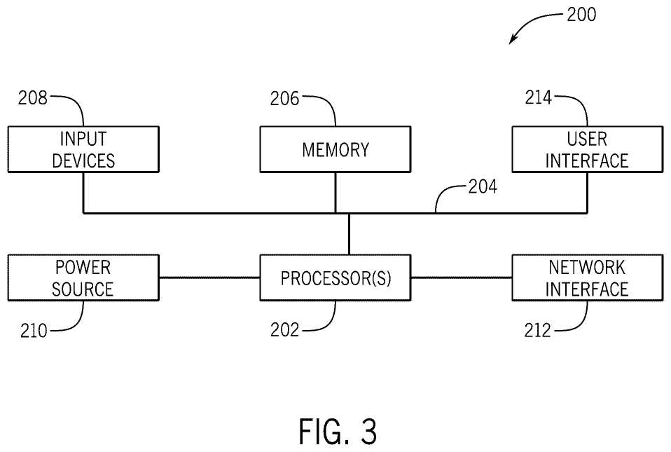

By way of background, it may be appreciated that the present approach may be implemented using one or more processor-based systems such as shown in FIG. 3. Likewise, applications and/or databases utilized in the present approach may be stored, employed, and/or maintained on such processor-based systems. As may be appreciated, such systems as shown in FIG. 3 may be present in a distributed computing environment, a networked environment, or other multi-computer platform or architecture. Likewise, systems such as that shown in FIG. 3, may be used in supporting or communicating with one or more virtual environments or computational instances on which the present approach may be implemented.

With this in mind, an example computer system may include some or all of the computer components depicted in FIG. 3. FIG. 3 generally illustrates a block diagram of example components of a computing system 200 and their potential interconnections or communication paths, such as along one or more busses. As illustrated, the computing system 200 may include various hardware components such as, but not limited to, one or more processors 202, one or more busses 204, memory 206, input devices 208, a power source 210, a network interface 212, a user interface 214, and/or other computer components useful in performing the functions described herein.

The one or more processors 202 may include one or more microprocessors capable of performing instructions stored in the memory 206. Additionally or alternatively, the one or more processors 202 may include application-specific integrated circuits (ASICs), field-programmable gate arrays (FPGAs), and/or other devices designed to perform some or all of the functions discussed herein without calling instructions from the memory 206.

With respect to other components, the one or more busses 204 include suitable electrical channels to provide data and/or power between the various components of the computing system 200. The memory 206 may include any tangible, non-transitory, and computer-readable storage media. Although shown as a single block in FIG. 1, the memory 206 can be implemented using multiple physical units of the same or different types in one or more physical locations. The input devices 208 correspond to structures to input data and/or commands to the one or more processors 202. For example, the input devices 208 may include a mouse, touchpad, touchscreen, keyboard and the like. The power source 210 can be any suitable source for power of the various components of the computing system 200, such as line power and/or a battery source. The network interface 212 includes one or more transceivers capable of communicating with other devices over one or more networks (e.g., a communication channel). The network interface 212 may provide a wired network interface or a wireless network interface. A user interface 214 may include a display that is configured to display text or images transferred to it from the one or more processors 202. In addition and/or alternative to the display, the user interface 214 may include other devices for interfacing with a user, such as lights (e.g., LEDs), speakers, and the like.

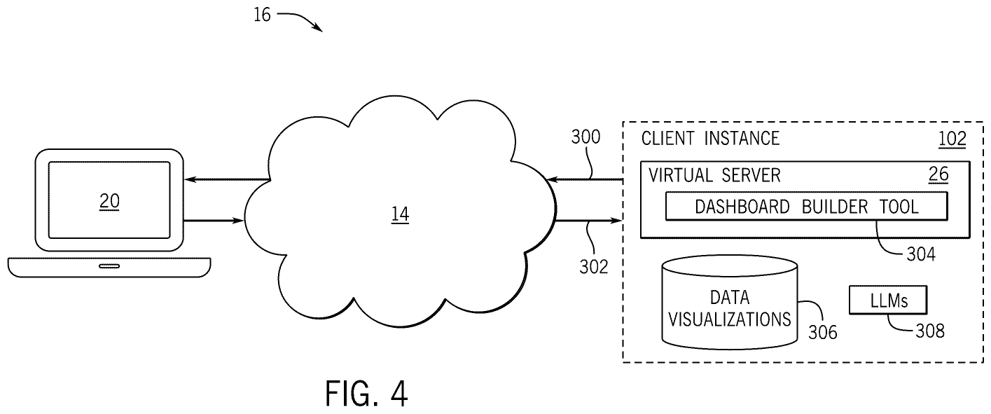

With the preceding in mind, FIG. 4 is a block diagram illustrating an embodiment in which a virtual server 26 supports and enables the client instance 102, according to one or more disclosed embodiments. More specifically, FIG. 4 illustrates an example of a portion of a service provider cloud infrastructure, including the cloud-based platform 16 discussed above. The cloud-based platform 16 is connected to a client device 20 via the network 14 to provide a user interface and/or a development environment for generating and displaying data visualizations, to network applications executing within the client instance 102 (e.g., via a web browser or a native application running on the client device 20). Client instance 102 is supported by virtual servers 26 similar to those explained with respect to FIG. 2, and is illustrated here to show support for the disclosed functionality described herein within the client instance 102. Cloud provider infrastructures are generally configured to support a plurality of end-user devices, such as client device(s) 20, concurrently, wherein each end-user device is in communication with the single client instance 102. Also, cloud provider infrastructures may be configured to support any number of client instances, such as client instance 102, concurrently, with each of the instances in communication with one or more end-user devices. As mentioned above, an end-user may also interface with client instance 102 using an application that is executed within a web browser.

As shown, the client device 20 may interact with the client instance 102 by providing inputs 300, to which the client instance 102 may respond with outputs 302. In the embodiment shown in shown in FIG. 4, the virtual server 26 of the client instance 120 may run a dashboard builder 304, which may be a software application defined by code, accessible via a native application or web browser of the client device 20. Accordingly, the inputs 300 may include a natural language input request to generate a dashboard and/or a system prompt including one or more KPIs. For example, the natural language input may include one or more use cases of the dashboard, and the system prompt may include KPIs associated with an organization, parameters of the KPIs, descriptions of how to use each KPI, and so on. Correspondingly, the outputs 302 may include a generated dashboard with one or more data visualizations corresponding to the KPIs (e.g., instructions to update a dashboard to include the data visualizations), responses to inputs 300, and so forth. For example, one or more data visualizations may be requested for a use case to analyze open and closed incidents of an organization. Accordingly, the dashboard may include one or more data visualizations that provide an overview of KPIs related to the open and closed incidents of the organization.

The dashboard builder 304 may utilize a data visualization database 306 and/or one or more large language models (LLMs) 308, each of which may be stored within the client instance or otherwise made accessible to the client instance, to generate some or all of the outputs 302. The data visualization database 306 may store data associated with previously generated data visualizations (e.g., line graphs, bar charts, scatter plots, pie charts) and/or structures of data visualizations that correspond to one or more KPIs and that assist in interpreting and analyzing the one or more KPIs. In some cases, the data visualizations stored in the data visualization database 306 may include data visualizations generated by the dashboard builder 304 in response to prior inputs 300 and/or a default or initial set of data visualizations. Additionally or alternatively, the dashboard builder 304 may use a library of data visualizations to generate the dashboard, and the library may be stored on a memory device accessible by the dashboard builder 304.

The one or more LLMs 308 may be trained on other use cases and/or other KPIs and may be used by the dashboard builder 304 to identify one or more applicable KPIs for which to generate one or more data visualizations. For example, the dashboard builder 304 may provide a natural language input and system prompt to the one or more LLMs 308, and the one or more LLMs 308 may provide one or more applicable KPIs as output. As used herein, a large language model (LLMs) is a probabilistic model of a natural language used for general-purpose language generation. LLMs typically include one or more artificial neural networks having a transformer-based architecture. LLMs learn statistical relationships from text documents through training processes that may be supervised, semi-supervised, or self-supervised. During training, LLMs may learn syntax, semantics, and/or ontology. LLMs, when used for text generation, receive an input text and iteratively predict the next word or token. It should be understood that the client instance 102 shown in FIG. 4 may be utilized by the client device 20 for other tasks associated with generating a dashboard including data visualizations of KPIs, as well as tasks beyond the scope of generating a dashboard including data visualizations of KPIs.

Traditionally, identifying applicable KPIs and developing useful data visualizations can be computationally expensive. Organizations may track numerous KPIs, each having various data source definitions, units, directions, precisions, aggregates, and other parameters. With so many KPIs and associated parameters, it may be difficult and/or computationally expensive to identify and efficiently produce visualizations of applicable KPIs, which may lead to the omission of important data when making organizational decisions.

The presently disclosed dashboard builder 304 receives a natural language request to generate a dashboard and a system prompt including one or more KPIs, identifies an applicable KPI of the one or more KPIs, identifies a data visualization for the applicable KPI, and generates a dashboard including the data visualization for the applicable KPI. In particular, the natural language input may specify a use case of the dashboard, and the dashboard builder 304 may use the one or more LLMs 308 to identify the applicable KPI based on the use case of the dashboard. The system prompt may define KPIs associated with an organization, parameters of the KPIs, and descriptions of how to use each KPI. As used herein, a use case may include an analysis goal or situation for which a data visualization of an applicable KPI may be useful. The natural language request specifying the use case may be received, for example, as user input to a chatbot or other natural language input source, and may include instructions to update the dashboard according to the use case.

The dashboard builder 304 may then determine whether one or more data visualizations (e.g., stored in the data visualization database 306) are associated with each applicable KPI. If one or more previously-generated data visualizations are associated with the applicable KPI, the dashboard builder 304 may map the one or more previously-generated data visualizations to the applicable KPI. If no data visualization is associated with the applicable KPI, the dashboard builder 304 may generate one or more data visualizations based on the KPI and information associated with the KPI included in the system prompt. For example, the dashboard builder 304 may utilize one or more software libraries and/or functions to generate a data visualization based on the information included in the system prompt. After mapping or generating one or more data visualizations for each applicable KPI, the dashboard builder 304 may generate a dashboard including the one or more data visualizations.

Further, additional natural language inputs (e.g., “show me incident-related indicators of potential breaches”) may be provided as inputs 300, and the dashboard builder 304 may update the dashboard based on the additional natural language inputs. For example, the dashboard builder 304 may provide the additional natural language inputs and the system prompt to the one or more LLMs 308, and the one or more LLMs 308 may identify one or more additional applicable KPIs of the one or more KPIs. The dashboard builder 304 may map one or more additional previously-generated data visualizations to the additional applicable KPIs or, alternatively, may generate the one or more additional data visualizations. The dashboard builder may then update the dashboard to include the one or more additional data visualizations.

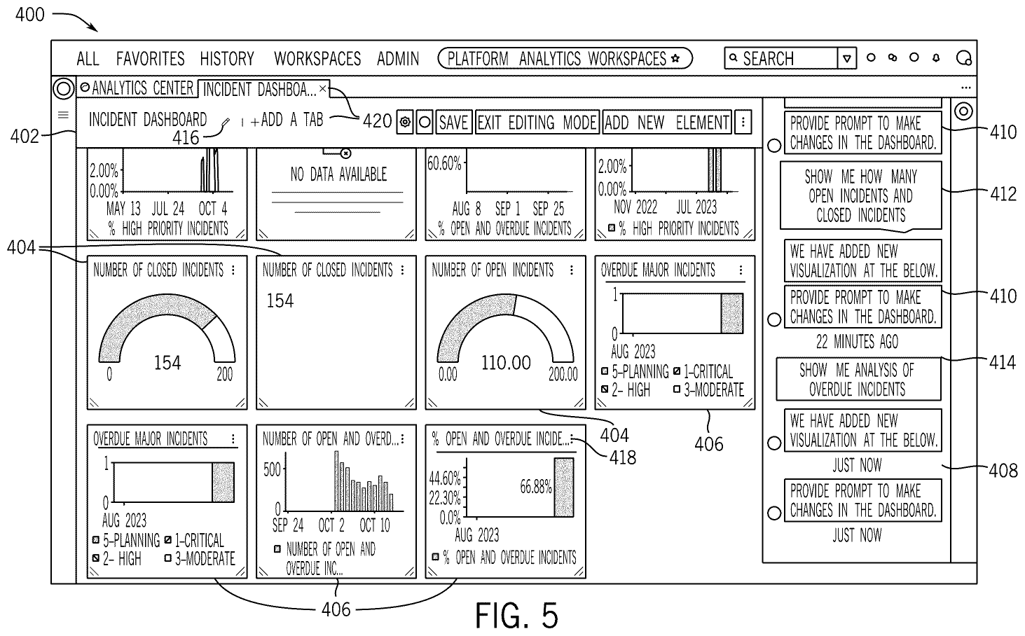

With the foregoing in mind, FIG. 5 represents an example screenshot of a workspace that may display a dashboard generated using the dashboard builder 304. It should be understood, however, that the screenshot depicted in FIG. 5 is merely an example and that embodiments having different dashboards, and dashboards having different data visualizations, are envisaged and are encompassed by the present description. Specifically, FIG. 5 is a screenshot of a workspace 400 including a dashboard 402 with data visualizations 404 and 406. As illustrated, the workspace 400 also includes a chat interface 408 that may display system messages 410 including instructions to provide a prompt to make changes to the dashboard 402.

The chat interface 408 may also facilitate receiving user messages in response to the system messages 410. In particular, the user messages may include a first natural language input 412 specifying a first use case and a second natural language input 414 specifying a second use case (e.g., an additional use case). The first natural language input 412 and second natural language input 414 may be provided as input to the dashboard builder 304. In response, the dashboard builder 304 may provide instructions to update the dashboard 402 to include the data visualizations 404 and 406. Additionally, the dashboard builder tool may provide instructions to update the chat interface 408 to include an indication that the data visualizations 404 and 406 have been added to the dashboard 402, as illustrated.

The dashboard builder 304 may receive natural language inputs and provide instructions to update the dashboard 402 sequentially. For example, the dashboard builder 304 may first receive, as input, the first natural language input 412 along with a system prompt including KPIs associated with an organization, parameters of the KPIs, and descriptions of how to use each KPI. As illustrated, the first natural language input 412 may specify open incidents and closed incidents as a use case. In some cases, the system prompt is received prior to receiving the first natural language input 412 and mapped to future natural language inputs associated with an organization, business, or the like. In other cases, the system prompt may be received as input with each natural language input.

The dashboard builder 304 may provide the first natural language input 412 and the system prompt to the one or more LLMs 308. In response, the one or more LLMs 308 may, based on the first natural language input 412 and the system prompt, identify one or more applicable KPIs for which to generate one or more data visualizations. For example, the one or more LLMs 308 may identify applicable KPIs including a number of closed incidents and a number of open incidents based on the first natural language input 412 and the KPIs included in the system prompt.

The dashboard builder 304 may then determine whether one or more previously-generated data visualizations are associated with each applicable KPI. If one or more previously-generated data visualizations are associated with the applicable KPI, the dashboard builder may map the one or more previously-generated data visualizations to the applicable KPI. If no data visualization is associated with the applicable KPI, the dashboard builder 304 may generate one or more data visualizations based on the KPI and information associated with the KPI included in the system prompt. For example, the dashboard builder 304 may provide the first natural language input 412 and the system prompt to the one or more LLMs 308, and the one or more LLMs 308 may identify one or more aspects of a data visualization, such as a type of data visualization (e.g., column series, pie chart), units, precisions, descriptions, and the like. The dashboard builder 304 may then generate a data visualization for the applicable KPI according to the aspects identified by the one or more LLMs 308.

After mapping or generating one or more data visualizations for each applicable KPI, the dashboard builder 304 may update the dashboard 402 to include the data visualizations 404. As illustrated, the dashboard builder may identify data visualizations of varying complexities and format. In the illustrated embodiment, the data visualizations 404 include basic representations of closed incidents along with proportional representations of open and closed incidents that may provide an easily interpretable view of those incidents (e.g., as a fraction of total incidents). As mentioned, the dashboard builder 304 may also update the chat interface 408 to include an indication that the data visualizations 404 have been added to the dashboard 402, along with a system message to provide a prompt (e.g., another natural language input) to make additional changes to the dashboard.

The dashboard builder 304 may then receive the second natural language input 414, which may specify an additional use case, via the chat interface 408 and may update the dashboard 402 to include the data visualizations 406 (e.g., additional data visualizations). For example, the dashboard builder 304 may provide the second natural language input 414 and the system prompt to the one or more LLMs, and the one or more LLMs may identify one or more additional applicable KPIs of the one or more KPIs of the system prompt. The one or more additional applicable KPIs may include, for instance, a number of overdue major incidents, importance metrics of the overdue major incidents, dates associated with open and overdue incidents, and a percentage of open and overdue incidents.

The dashboard builder may map one or more additional previously-generated data visualizations to the additional applicable KPIs or, alternatively, may generate the one or more additional data visualizations based on aspects of the applicable KPIs included in the system prompt, as described herein. The dashboard builder may then update the dashboard to include the data visualizations 406 as additional data visualizations. Additionally or alternatively, the dashboard builder may generate a dashboard including the data visualizations 404 and the data visualizations 406 (e.g., as part of the same dashboard). As illustrated, the chat interface 408 may also be updated to include an indication of the changes to the dashboard 402 and instructions to provide additional natural language inputs.

The data visualizations 406 include a bar chart of overdue major incidents with color-coded value indications, a bar chart indicating a number of open and overdue incidents by date, and a bar chart indicating a percentage representation of a portion of incidents are open and overdue. As such, the dashboard may aide in analyzing KPIs of overdue incidents by providing numerous and different insights of the KPIs graphically. It should be noted that while FIG. 5 illustrates example natural language inputs, KPIs, and data visualizations, other embodiments are envisioned. As may be appreciated, various natural language inputs may be received as inputs, various applicable KPIs may be identified based on the various natural language inputs, and various data visualizations may be mapped to, or generated for, the various applicable KPIs.

Additional inputs may be received to edit the dashboard, such as keystrokes, clicks, and the like. For example, input at a dashboard edit button may facilitate rearranging, reformatting, deletion, duplication, or other changes to the dashboard 402. Similarly, input at a data visualization edit button 418 may facilitate further inspection or alteration to a data visualization of the data visualizations 404 and 406. Further, tab controls 420 may allow grouping (e.g., categorization) of data visualizations to ease analysis. Additionally or alternatively, the chat interface 408 may facilitate control of the dashboard 402 or data visualizations 404 and 406.

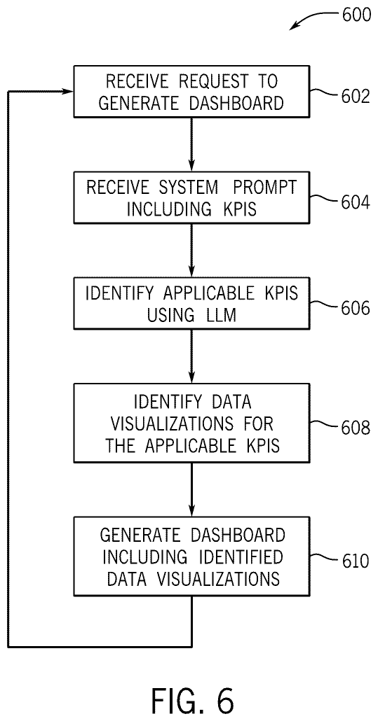

FIG. 6 is a flowchart of a process 600 for generating a dashboard including data visualizations of applicable KPIs based on a natural language request and a system prompt. The process 600 may be performed by the client instance 102, the virtual server 26, the client device 20, a computing device or controller disclosed above with reference to FIG. 1 or any other suitable computing device(s) or controller(s). Furthermore, the blocks of the process 600 may be performed in the order disclosed herein or in any suitable order. For example, certain blocks of the process may be performed concurrently. In addition, in certain embodiments, at least one of the blocks of the process 600 may be omitted.

The process 600 may begin, in block 602, with receiving a natural language request to generate a dashboard. As described herein, the natural language request may be received via a suitable natural language input interface, such as the chat interface 408 of FIG. 5, a voice input, or the like. The natural language request may specify a use case of the dashboard, such as an organizational parameter or performance metric to be analyzed.

The process 600 may continue, in block 604, with receiving a system prompt. The system prompt may include KPIs associated with an organization, parameters of the KPIs, and descriptions of how to use each KPI. As described herein, the system prompt may be received with each natural language input, or may be received beforehand and associated with natural language inputs from a particular chat interface, or from a particular client instance of an organization, business, or the like.

In block 606, the process may identify one or more applicable KPIs of the KPIs of the system prompt using one or more LLMs. The one or more LLMs may, based on the natural language input and the system prompt, identify one or more applicable KPIs for which to generate one or more data visualizations. As mentioned herein, the one or more LLMs may be trained based on other use cases (e.g., of other natural language inputs), other KPIs, other KPI parameters, and the like. The applicable KPIs may correspond to the use case specified by the natural language request. For example, if the natural language request specifies a use case related to overdue incidents, the applicable KPIs may include a percentage of overdue incidents, dates of overdue incidents, types of overdue incidents, and so on. As such, using the disclosed techniques to identify applicable KPIs may be more computationally efficient that manually searching numerous KPIs associated with an organization.

In block 608, one or more data visualizations may be identified for the applicable KPIs identified in block 606. This may include determining whether one or more previously-generated data visualizations are associated with the applicable KPI. If a previously-generated data visualization is associated with the applicable KPI, the previously-generated data visualizations may be identified for (e.g., mapped to) the applicable KPI. If, however, no previously-generated data visualization is associated with the applicable KPI, one or more data visualizations may be generated for the applicable KPI based on the applicable KPI, parameters of the applicable KPI, and other information included with the system prompt.

In block 610, a dashboard including the identified data visualizations may be generated. Block 610 may also include updating a dashboard or workspace to include an indication that the dashboard has been generated or updated to include the identified data visualizations. For example, a chat interface, such as the chat interface of FIG. 5, may display a message indicating that a new data visualization has been added to the dashboard along with a prompt to provide additional natural language requests to change the dashboard. Generating a dashboard according to the disclosed techniques may provide a holistic and easily-interpretable overview of KPIs applicable to a use case of an organization, and may be more resource-efficient than manually searching for applicable KPIs and/or creating data visualizations of the applicable KPIs.

Once the dashboard with the identified data visualizations has been generated, the process 600 may return to block 602 by receiving an additional natural language request. The additional natural language request and the system prompt may be provided to the one or more LLMs, and the one or more LLMs may identify one or more additional applicable KPIs of the one or more KPIs. The dashboard builder may map one or more additional previously-generated data visualizations to the additional applicable KPIs or, alternatively, may generate the one or more additional data visualizations. The dashboard may then be updated to include the one or more additional data visualizations along with an indication that additional data visualizations have been added to the dashboard.

Various embodiments disclosed herein are directed to a dashboard builder that displays data visualizations of KPIs based on natural language inputs provided to large language models (LLMs). Specifically, a natural language input identifying one or more use cases of a dashboard (e.g., “Create a dashboard which helps me analyze, open, and close overdue and high priority incidents”) may be provided as an input. Additionally, the dashboard builder may receive a system prompt including KPIs associated with an organization, parameters of the KPIs, and descriptions of how to use each KPI. The dashboard builder may provide the natural language input and the system prompt to one or more LLMs trained on other use cases and/or other KPIs.

The one or more LLMs may, based on the natural language input and the system prompt, identify one or more applicable KPIs for which to generate one or more data visualizations. The dashboard builder may then determine whether one or more previously-generated data visualizations are associated with each applicable KPI. If one or more previously-generated data visualizations are associated with the applicable KPI, the dashboard builder may map the one or more previously-generated data visualizations to the applicable KPI. If no data visualization is associated with the applicable KPI, the dashboard builder may generate one or more data visualizations based on the KPI and information associated with the KPI included in the system prompt. After mapping or generating one or more data visualizations for each applicable KPI, the dashboard builder may generate a dashboard including the one or more data visualizations.

Additional natural language inputs (e.g., “show me incident-related indicators of potential breaches”) may be provided, and the dashboard builder may update the dashboard based on the additional natural language inputs. For example, the dashboard builder may provide the additional natural language inputs and the system prompt to the one or more LLMs, and the one or more LLMs may identify one or more additional applicable KPIs of the one or more KPIs. The dashboard builder may map one or more additional previously-generated data visualizations to the additional applicable KPIs or, alternatively, may generate the one or more additional data visualizations. The dashboard builder may then update the dashboard to include the one or more additional data visualizations.

The disclosed dashboard builder may result in faster and more computationally efficient identification of KPIs applicable to a use case of an organization, especially when KPIs associated with an organization are numerous and/or complex. Further, generation of a dashboard including data visualizations of applicable KPIs according to the techniques described herein may provide a more complete and interpretable presentation of applicable KPIs, and may be more efficient than manually generating such visualizations.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function]. . . ” or “step for [perform]ing [a function]. . . ”, it is intended that such elements are to be interpreted under 35 U.S.C. 112(f). However, for any claims containing elements designated in any other manner, it is intended that such elements are not to be interpreted under 35 U.S.C. 112(f).

1. A method comprising:
receiving a natural language request to generate a dashboard, wherein the natural language request specifies a use case of the dashboard;
receiving a system prompt comprising one or more key performance indicators (KPIs);
identifying, using a large language model (LLM), an applicable KPI of the one or more KPIs based on the use case of the dashboard;
identifying a data visualization for the applicable KPI; and
generating a dashboard including the data visualization for the applicable KPI.

2. The method of claim 1, wherein the system prompt comprises one or more parameters of each of the one or more KPIs, a description of a respective use case of each of the one or more KPIs, or both.

3. The method of claim 2, comprising:
identifying, using the LLM, an additional KPI of the one or more KPIs based on the use case of the dashboard;
generating an additional data visualization for the additional KPI based on the one or more parameters of the additional KPI, the description of the respective use case of the additional KPI, or both; and
generating the dashboard including the data visualization for the applicable KPI and the additional data visualization for the additional KPI.

4. The method of claim 1, comprising:
receiving an additional natural language request to update the dashboard, wherein the additional natural language request specifies an additional use cases of the dashboard;
identifying, using the LLM, an additional KPI of the one or more KPIs based on the additional use case of the dashboard;
identifying an additional data visualization for the additional KPI; and
generating a dashboard including the additional data visualization for the additional KPI.

5. The method of claim 4, wherein the dashboard includes an indication that the additional data visualization has been generated.

6. The method of claim 4, wherein the additional natural language request to update the dashboard is received via a chat interface.

7. The method of claim 1, wherein the LLM is trained on one or more other KPIs, one or more other use cases, one or more other data visualizations, one or more other dashboards, or a combination thereof.

8. The method of claim 1, wherein the data visualization comprises a chart or graph.

9. A system, comprising:
processing circuitry; and
a memory, accessible by the processing circuitry, and storing instructions that, when executed by the processing circuitry, cause the processing circuitry to perform operations comprising:
receiving a natural language request to generate a dashboard, wherein the natural language request specifies a use case of the dashboard;
receiving a system prompt comprising one or more key performance indicators (KPIs);
identifying, using a large language model (LLM), an applicable KPI of the one or more KPIs based on the use case of the dashboard;
identifying a data visualization for the applicable KPI; and
generating a dashboard including the data visualization for the applicable KPI.

10. The system of claim 9, wherein the data visualization is stored in a database accessible by the processing circuitry.

11. The system of claim 9, wherein the system prompt comprises one or more parameters of each of the one or more KPIs, a description of a respective use case of each of the one or more KPIs, or both.

12. The system of claim 11, wherein the operations comprise:
identifying, using the LLM, an additional KPI of the one or more KPIs based on the use case of the dashboard;
generating an additional data visualization for the additional KPI based on the one or more parameters of the additional KPI, the description of the respective use case of the additional KPI, or both; and
generating the dashboard including the data visualization for the applicable KPI and the additional data visualization for the additional KPI.

13. The system of claim 9, wherein the operations comprise:
receiving an additional natural language request to update the dashboard, wherein the additional natural language request specifies an additional use cases of the dashboard;
identifying, using the LLM, an additional KPI of the one or more KPIs based on the additional use case of the dashboard;
identifying an additional data visualization for the additional KPI; and
generating a dashboard including the additional data visualization for the additional KPI.

14. The system of claim 13, wherein the data visualization and the additional data visualization are generated as part of the same dashboard.

15. The system of claim 13, wherein the additional natural language request to update the dashboard is received via a chat interface.

16. The system of claim 15, wherein the dashboard comprises the chat interface.

17. The system of claim 9, wherein the data visualization comprises a chart or graph.

18. A non-transitory, computer readable medium comprising instructions that, when executed by processing circuitry, cause the processing circuitry to perform operations comprising:
receiving a natural language request to generate a dashboard, wherein the natural language request specifies a use case of the dashboard;
receiving a system prompt comprising one or more key performance indicators (KPIs);
identifying, using a large language model (LLM), an applicable KPI of the one or more KPIs based on the use case of the dashboard;
identifying a data visualization for the applicable KPI; and
generating a dashboard including the data visualization for the applicable KPI.

19. The non-transitory, computer readable medium of claim 18, wherein the LLM is trained on one or more other KPIs, one or more other use cases, one or more other data visualizations, one or more other dashboards, or a combination thereof.

20. The non-transitory, computer readable medium of claim 18, wherein the instructions cause the processing circuitry to perform operations comprising:
receiving an additional natural language request to update the dashboard, wherein the additional natural language request specifies an additional use cases of the dashboard;
identifying, using the LLM, an additional KPI of the one or more KPIs based on the additional use case of the dashboard;
identifying an additional data visualization for the additional KPI; and
generating a dashboard including the additional data visualization for the additional KPI.
